(19) United States
(12) Patent Application Publication
(10) Pub. No.: US 2013/0118454 A1
(43) Pub. Date: May 16, 2013

(54) VARIABLE COMPRESSION RATIO APPARATUS

(71) Applicants: Yoonsik Woo, Yongin-si (KR); Juhun Lee, Gwangmyeong-si (KR); Dongseok Lee, Hwaseong-si (KR); Eunho Lee, Hwaseong-si (KR); Jinkook Kong, Suwon-si (KR); Soohyung Woo, Yongin-si (KR)

(72) Inventors: Yoonsik Woo, Yongin-si (KR); Juhun Lee, Gwangmyeong-si (KR); Dongseok Lee, Hwaseong-si (KR); Eunho Lee, Hwaseong-si (KR); Jinkook Kong, Suwon-si (KR); Soohyung Woo, Yongin-si (KR)

(73) Assignee: Hyundai Motor Company, Seoul (KR)

(21) Appl. No.: 13/488,140

(22) Filed: Jun. 4, 2012

(30) Foreign Application Priority Data
Nov. 14, 2011 (KR) 10-2011-0118188

(51) Int. Cl. F02D 15/02; F02B 75/04

(52) U.S. Cl. 123/48 B

(57) ABSTRACT

A variable compression ratio (VCR) apparatus, may include a piston forming a combustion chamber, a connecting rod having one end rotatably coupled to the piston through a piston pin so as to transmit a motion of the piston to a crank shaft, dual eccentric links having one ends eccentrically connected to the one end of the connecting rod through the piston pin, and dual swing links having one ends pivotally connected to the other ends of the eccentric links, respectively, so as to pivot the eccentric links with respect to the piston pin.

### CROSS-REFERENCE TO RELATED APPLICATIONS

The present application claims priority to Korean Patent Application Number 10-2011-0118188, filed Nov. 14, 2011, the entire contents of which application is incorporated herein for all purposes by this reference.

### BACKGROUND OF THE INVENTION

1. Field of the Invention

The present invention relates to a variable compression ratio (VCR) apparatus, and more particularly, to a VCR apparatus having dual eccentric links and dual swing links.

2. Description of Related Art

In general, the thermal efficiency of a heat engine increases when a compression ratio is high. In the case of a spark ignition engine, the thermal efficiency thereof increases when ignition timing is advanced to a predetermined level.

In the spark ignition engine, however, when the ignition timing is advanced at a high compression ratio, abnormal combustion may occur to cause engine damage. Therefore, there is a limit in advancing the ignition timing. Thus, the spark ignition engine should endure an output reduction.

A VCR apparatus serves to change the compression ratio of gas mixture depending on an operation state of an engine.

The VCR apparatus improves fuel efficiency by increasing the compression ratio of the gas mixture in a low-load condition of the engine. Further, the VCR apparatus prevents the occurrence of knocking and improves engine power by reducing the compression ratio of the gas mixture in a high-load condition of the engine.

U.S. Pat. No. 6,581,552 has disclosed a VCR apparatus according to the related art. The VCR apparatus includes a connecting rod having one end connected to a piston forming a combustion chamber and the other end connected to a crank shaft. The one end of the connecting rod, connected to the piston, is coupled to an eccentric ring. The eccentric ring is connected to one end of an eccentric swing member. The other end of the eccentric swing member is connected to a slide through a coupling. The slide is connected to a driving device so as to be moved by the driving device.

The slide is moved by the operation of the driving device, and the motion of the slide is transmitted to the eccentric swing member through the coupling so as to rotate the eccentric swing member. The rotation of the eccentric swing member varies the top dead center of the piston through the connecting rod, thereby changing the compression ratio of the combustion chamber formed by the piston.

In the VCR apparatus according to the related art, the structural stiffness and stable operation of the eccentric swing member are required, and the structure of the eccentric swing member needs to be simplified.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide a VCR apparatus capable of securing dynamic stability of a swing operation and improving assembling workability and having structural stiffness.

In an aspect of the present invention, a variable compression ratio (VCR) apparatus, may include a piston forming a combustion chamber, a connecting rod having one end rotatably coupled to the piston through a piston pin so as to transmit a motion of the piston to a crank shaft, dual eccentric links having one ends eccentrically connected to the one end of the connecting rod through the piston pin, and dual swing links having one ends pivotally connected to the other ends of the eccentric links, respectively, so as to pivot the eccentric links with respect to the piston pin.

The eccentric links may have circular bosses formed at the one ends thereof and facing each other, and the bosses may have assembling holes eccentrically formed and coupled to the piston pin.

The eccentric links may have assembling grooves formed at the other ends thereof and coupled to the one ends of the swing links through a pin.

The swing links may have assembling grooves formed at the one ends thereof, and the other ends of the eccentric links are inserted into the assembling grooves such that the one ends of the swing links are pivotally coupled to the other ends of the eccentric links through the pin.

The other ends of the swing links are integrally connected to each other at a connection portion so as to form one body, and the connection portion may have a pin boss extended in two parts in the opposite direction of the one ends of the swing links such that a driving device for swinging the swing links is connected to the swing links through the pin boss and a pin.

The piston may have an assembling groove recessed from a bottom thereof, and the one ends of the eccentric links are slidably inserted into the assembling groove such that a swing operation of the eccentric links is guided by both side surfaces of the assembling groove.

In the VCR apparatus according to the exemplary embodiment of the present invention, the eccentric links having one ends coupled to the piston and the connecting rod are constructed in a dual link type such that a load is uniformly distributed to the dual eccentric links.. Therefore, the VCR apparatus has an advantage in terms of load balancing, the structural stiffness as well as the dynamic stability during the swing operation of the eccentric links may be improved, and partial abrasion of a main bearing may be prevented. As the eccentric links perform a stable swing operation, a guide unit for improving the motion stability of the eccentric links is not necessary. Therefore, the structure may be simplified, and the apparatus may be easily manufactured. Further, the pin boss of the piston pin connecting the piston and the connecting rod may be utilized as a guide for controlling a thrust load. Thus, a separate guide device for guiding a thrust load is not necessary.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of a VCR apparatus according to an exemplary embodiment of the present invention.

FIG. 2 is a perspective view of dual eccentric links according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

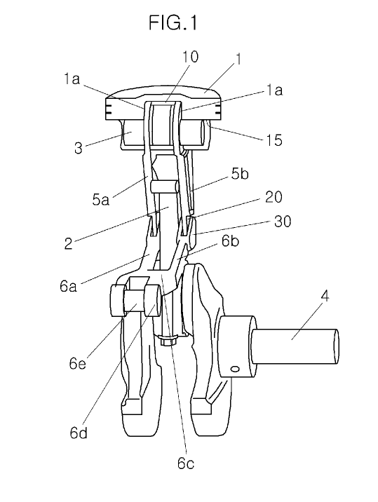

Referring to FIG. 1, a piston 1 forming a combustion chamber has an assembling groove formed toward the inside from the bottom thereof, and a connecting rod 2 has one end inserted into the assembling groove and coupled to a piston pin 3.

Piston 1 has an assembling hole 15 formed in a diametric direction and communicating with the assembling groove 10, and piston pin 3 is inserted into the assembling hole 15 to connect one end of connecting rod 2 to piston 1.

The other end of connecting rod 2 is coupled to a crank shaft 4 so as to convert a vertical motion of the connecting rod into a rotational motion of crank shaft 4.

At both sides of connecting rod 2, dual eccentric links 5a and 5b are disposed. Eccentric links 5a and 5b have one ends inserted into the assembling groove of piston 1 and connected to the one end of connecting rod 2 through piston pin 3.

Both side surfaces 1a of assembling groove 10 serve as a guide when eccentric links 5a and 5b perform a swing operation, thereby improving the stability of the swing operation of eccentric links 5a and 5b.

The other ends of eccentric links 5a and 5b are connected to one ends of dual swing links 6a and 6b, respectively.

Swing links 6a and 6b have assembling grooves 20 formed in the one ends thereof, respectively, and the other ends of eccentric links 5a and 5b are inserted into the assembling grooves 20 such that the one ends of swing links 6a and 6b are coupled to the other ends of eccentric links 5a and 5b through a pin 30.

The other ends of swing links 6a and 6b are integrally connected to each other at a connection portion 6c so as to form one body, and connection portion 6c has a pin boss 6d extended in two parts in the opposite direction of the one ends of swing links 6a and 6b such that a driving device for swinging swing links 6a and 6b is connected to swing links 6a and 6b through pin boss 6d and a pin 6e.

The driving device may include an electric driving device such as a motor or a hydraulic system operated by oil pressure.

Swing links 6a and 6b are swung by the operation of the driving device, and the motion of the swing links is transmitted to eccentric links 5a and 5b to perform a swing motion. The swing motion of eccentric links 5a and 5b changes the top dead center of piston 1, thereby varying a compression ratio.

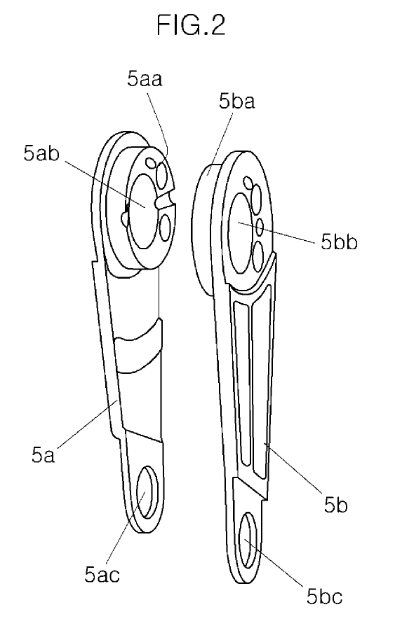

Referring to FIG. 2, circular bosses 5aa and 5ba are protruded at the one ends of eccentric links 5a and 5b so as to face each other, and assembling holes 5ab and 5bb are eccentrically formed through bosses 5aa and 5ba so as to deviate from the center of bosses 5aa and 5ba. Piston pin 3 is inserted through assembling holes 5ab and 5bb.

Eccentric links 5a and 5b have assembling grooves 5ac and 5bc formed through the other ends thereof, and the other ends of the eccentric links are inserted into the assembling grooves 20 of swing links 6a and 6b and coupled through a pin inserted into the assembling holes 5ac and 5bc.

For convenience in explanation and accurate definition in the appended claims, the terms “upper”, “lower”, “inner” and “outer”, are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable compression ratio (VCR) apparatus, comprising:
a piston forming a combustion chamber;
a connecting rod having one end rotatably coupled to the piston through a piston pin so as to transmit a motion of the piston to a crank shaft;
dual eccentric links having one ends eccentrically connected to the one end of the connecting rod through the piston pin; and
dual swing links having one ends pivotally connected to the other ends of the eccentric links, respectively, so as to pivot the eccentric links with respect to the piston pin.

2. The VCR apparatus as defined in claim 1, wherein the eccentric links have circular bosses formed at the one ends thereof and facing each other, and the bosses have assembling holes eccentrically formed and coupled to the piston pin.

3. The VCR apparatus as defined in claim 2, wherein the eccentric links have assembling grooves formed at the other ends thereof and coupled to the one ends of the swing links through a pin.

4. The VCR apparatus as defined in claim 3, wherein the swing links have assembling grooves formed at the one ends thereof, and the other ends of the eccentric links are inserted into the assembling grooves such that the one ends of the swing links are pivotally coupled to the other ends of the eccentric links through the pin.

5. The VCR apparatus as defined in claim 4, wherein the other ends of the swing links are integrally connected to each other at a connection portion so as to form one body, and the connection portion has a pin boss extended in two parts in the opposite direction of the one ends of the swing links such that a driving device for swinging the swing links is connected to the swing links through the pin boss and a pin.

6. The VCR apparatus as defined in claim 1, wherein the piston has an assembling groove recessed from a bottom thereof, and the one ends of the eccentric links are slidably inserted into the assembling groove such that a swing operation of the eccentric links is guided by both side surfaces of the assembling groove.
